(19) United States
(12) Patent Application Publication
(10) Pub. No.: US 2026/0026472 A1
(43) Pub. Date: Jan. 29, 2026

(54) Multipurpose Traction Enhancing and Insulating Sock

(71) Applicant: Misty Mason, Surprise, AZ (US)

(72) Inventor: Misty Mason, Surprise, AZ (US)

(21) Appl. No.: 19/348,442

(22) Filed: Oct. 2, 2025

Related U.S. Application Data
(63) Continuation-in-part of application No. 17/671,895, filed on Feb. 15, 2022.
(60) Provisional application No. 63/223,212, filed on Jul. 19, 2021.

(51) Int. Cl. A01K 13/00

(52) U.S. Cl. CPC A01K 13/007

(57) ABSTRACT

A protective flexible sock for animals is disclosed. The sock is designed to appear like a shoe and protects the lower leg and paws of animals from hot and cold surfaces, debris, road salt, germs and injury without impacting the animal's gait. The sock is made from a washable fabric, as well as weatherproof material coated with plastic including a heat-resistant felt insole and a rubber gripping exterior sole surface. The insole provides insulation to the paws of the animals and the rubber sole provides increased traction and stability. The sock protects pets from injuries and discomfort such as burning of the paws or developing sores, gait issues and mobility issues with their hips/joints without causing discomfort while wearing the socks. The fibers of the insulating insole absorb heat, swelling and thickening to fill the gaps in the sock.

### CROSS-REFERENCE TO RELATED APPLICATION

The present application is a continuation in part patent application of, and claims priority to and the benefit of, U.S. patent application Ser. No. 17/671,895, which was filed on Feb. 15, 2022, and claims priority to and the benefit of U.S. Provisional Patent Application No. 63/223,212, which was filed on Jul. 19, 2021, both of which are incorporated herein by reference in their entirety.

### FIELD OF THE INVENTION

The present invention relates generally to the field of animal shoes, socks and paw covers. More specifically, the present invention relates to a novel lightweight and insulating sock for protecting a pet's paws from external cold or hot surfaces, abrasions, slipping or other injury without impacting the animal's gait. The form fitting shaped sock is designed to be easily worn and flexible in order to be worn for long periods. The sock may include silicon dots for increasing traction and support and includes an insulating insole for providing insulation from cold and hot surfaces. The sock covers a portion of the ankle and may go up partial leg and the paw of the pet and maintains comfort for the pet while wearing the sock. Accordingly, the present disclosure makes specific reference thereto. Nonetheless, it is to be appreciated that aspects of the present invention are also equally applicable to other like applications, devices and methods of manufacture.

### BACKGROUND

By way of background, animals such as cats and dogs have sensitive paw pads that become vulnerable in the heat and cold. Surfaces such as pavement, driveway, asphalt, artificial grass and more can become extremely hot, thereby causing blisters or burns on their paw pads. Further, hot pavements can also increase an animal's overall body temperature that can lead to heat stroke. Burning of the paws can also be debilitating to the animals. The pets can also face excessive drooling and thickening of saliva, loss of consciousness, dizziness and lethargy due to walking on hot surfaces. Conversely, extreme cold can be encountered by pets when walking during the winter months. Snow and ice can build up between and underneath an animal's toes and paws, thereby creating an uncomfortable walking platform for the animal.

Usually, when the air temperature is 86 degrees Fahrenheit, the asphalt temperature is 135 degrees Fahrenheit, which is too hot for safely walking a dog or a cat. Further, skin destruction of a paw can occur in 60 seconds at 125 degrees Fahrenheit. Therefore, individuals desire a way to keep their pets/animals paws safe while walking on any surface even in high temperatures.

Similar problems are faced by pets in very cold temperatures. The pavements and other surfaces become icy in cold weather and can be harmful for pets. Individuals desire a way to keep their pets/animals' paws safe while walking on any surface even in icy, snowy and/or cold temperatures.

Usually, paw pads of the animals provide less traction on various surfaces such as tiles, vinyl, hardwood flooring and more. This leads to slipping and falling of animals when they run or even walk casually on such floors. Individuals desire a sock or boot that provides increased traction on slippery surfaces.

Generally, for animals such as dogs and cats, dresses, sweaters, pull-overs, t-shirts, et. al. are readily available that can be worn by animals on different occasions. However, matching socks are not available for pets/animals, which leads to incomplete dressing of the animals. Individuals desire socks that are available in multiple designs and colors to match or compliment the outfits of their animals. The socks may be customized for holidays or birthdays.

Therefore, there exists a long felt need in the art for an animal sock that protects pets' paws from hot surfaces. There is also a long felt need in the art for an animal sock that protects pets' paws from icy cold surfaces. Additionally, there is a long felt need in the art for an animal sock that increases traction of paws on any surface. Moreover, there is a long felt need in the art for a sock clothing article that prevents slipping and skidding of animals on slippery surfaces. Further, there is a long felt need in the art for an animal sock that maintains comfort for the pet while wearing the socks. Furthermore, there is a long felt need in the art for a sock that can match or compliment the outfit worn by the animal. Finally, there is a long felt need in the art for an animal sock that protects pets from injuries and discomfort, such as burning of the paws or developing sores when walking on any type of ground surface, and prevents slipping and falling by increasing traction.

The subject matter disclosed and claimed herein, in one embodiment thereof, comprises a multipurpose paw safety sock for animals. The paw safety sock protects feet and paws from hot and cold weather, dirt, chemicals, road salt and abrasion while providing increased traction. The sock includes a top opening for inserting an animal's leg and paw, a leg portion for enclosing the lower leg of the animal, a paw portion for covering the paw of the animal, a textured sole positioned at the bottom of the paw portion for increasing traction and stability and an insulating insole positioned inside the sock for providing insulation from hot or cold surfaces on which the animal walks while wearing the sock.

In this manner, the multipurpose animal sock of the present invention accomplishes all of the forgoing objectives and provides users with an improved animal sock with a heat-resistant sole and a rubber gripping. The sock may also utilize a water-resistant fabric to accommodate wet weather conditions, ensuring the socks can be worn outdoors during any type of weather. The sock protects pets from injuries and discomfort such as burning of the paws or developing sores when walking on any type of ground surface without impacting their gait.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose paw safety sock for animals. The paw safety sock is configured to protect feet and paws from hot and cold weather, dirt, chemicals and abrasion while providing increased traction. The sock further comprising a top opening for inserting an animal's leg and paw, the top opening includes a light reflective elastic band for securing the sock, a leg portion for enclosing lower leg of the animal, a paw portion for covering the paw of the animal, a textured sole positioned at the bottom of the paw portion for increasing traction and stability, an insulating insole positioned inside the sock for providing insulation from hot or cold surfaces on which the animal walks while wearing the sock, and a toe cap may be inserted for protecting the toe and claws of the animal wherein the insole is permanently sewn or attached to the fabric of the sock along the paw portion, and the rubber sole is attached using a permanent adhesive. The lower portion includes a transparent area enabling a user to view the leg of the animal without removing the sock.

In yet another embodiment, a flexible and insulating sock for covering the paw of an animal and having a shoe like presence and feel is disclosed. The sock comprising a top opening for putting the paw into the sock with possible options not limited to: a hook fastener positioned around the top opening, a loop fastener flap extending from the hook fastener and adapted to wrap around the hook fastener to secure the sock around the leg of the animal, an insulating insole for providing insulation to the paw from hot or cold surfaces on which the animal walks, a flexible silicon dots sole for increasing traction with the surface and providing more stability and support to the animal and possible toe cap for protecting the toes nails/claws of the animal.

In yet another embodiment, the sock is made from a breathable, resilient, and insulating fabric such as cotton or nylon and conforms to the shape of the leg of the animal.

In yet another embodiment, the sock is available in small, medium, large or extra-large sizes.

In yet another embodiment, the insulating insole provides cushioning to the paw of the animal and enables the animal to walk and run on hard surfaces and terrains.

In yet another embodiment, the sock includes the top open end and claw openings at the other or bottom end. The claw or nail openings are used for exposing the claws/nails of the animal and have claw/nail supporting members for preventing the claws/nails from touching the surface on which the animal is walking.

In yet another embodiment of the present invention, a method for donning a shoe like flexible sock for protecting animals from injuries and discomfort such as burning of paws and slipping on a surface is disclosed. The method includes providing a paw sock with the paw sock having a lower leg portion and a paw portion, then sliding the paw into the sock from a top opening with the lower leg portion supporting the lower leg and paw portion covering the paw and thereafter, attaching a potential hook and loop fastener around the top opening to secure the sock.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose animal sock of the present invention in accordance with the disclosed architecture;

FIG. 2 illustrates a perspective view showing another embodiment of an insulating animal paw sock of the present invention in accordance with the disclosed architecture;

FIG. 3 illustrates a perspective view showing the layered structure of the paw portion of the multipurpose animal sock of FIG. 1 in accordance with the disclosed architecture;

FIG. 4 illustrates a perspective view of a third embodiment of the multipurpose animal paw safety sock of the present invention in accordance with the disclosed architecture;

FIG. 5 illustrates a perspective view showing a dog running with the multipurpose sock of the present invention on a potentially hot surface in accordance with the disclosed architecture; and

FIG. 6 illustrates a flowchart showing an exemplary method for donning the sock of the present invention on a paw of an animal in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an animal sock that protects pets' paws from hot surfaces. There is also a long felt need in the art for an animal sock that protects pets' paws from icy cold surfaces. Additionally, there is a long felt need in the art for an animal sock that increases the traction of paws on any surface. Moreover, there is a long felt need in the art for a sock clothing article that prevents slipping and skidding of animals on slippery surfaces. Further, there is a long felt need in the art for an animal sock that maintains comfort for the pet while wearing the socks. Furthermore, there is a long felt need in the art for a sock that can match or compliment the outfit worn by the animal. Finally, there is a long felt need in the art for an animal sock that protects pets from injuries and discomfort, such as burning of the paws or developing sores when walking on any type of ground surface, and prevents slipping and falling by increasing traction.

The present invention, in one exemplary embodiment, is a novel flexible and insulating sock for covering the paw of an animal and having a shoe like presence and feel is disclosed. The sock comprising a top opening for putting the paw into the sock, a hook fastener positioned around the top opening, a potential loop fastener flap extending from the hook fastener and adapted to wrap around the hook fastener to secure the sock around leg of the animal, an insulating insole for providing insulation to the paw from hot or cold surfaces on which the animal walks, a flexible rubber sole for increasing traction with the surface and providing more stability and support to the animal, and a toe cap for protecting the claws/nails of the animal.

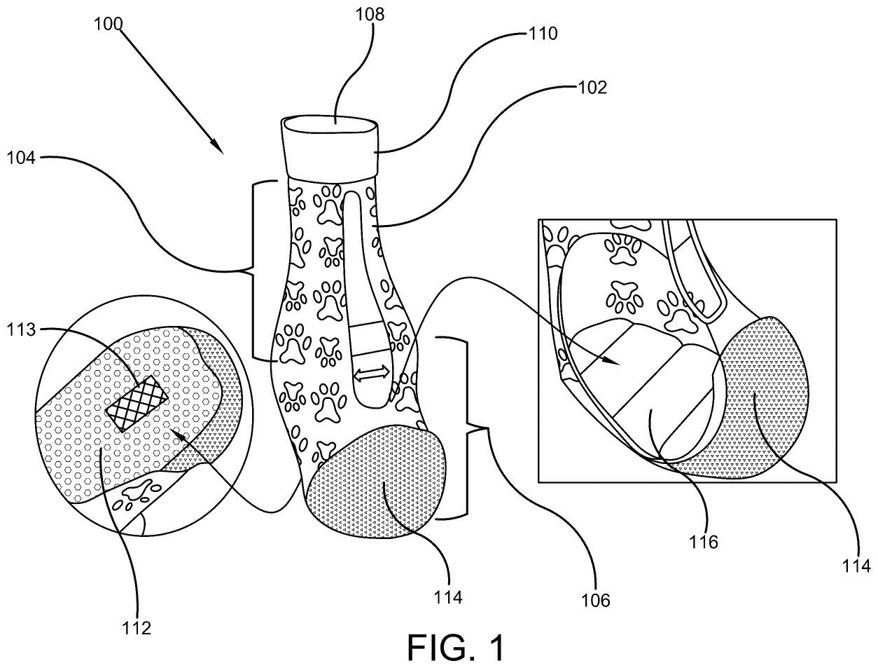

Referring initially to the drawings, FIG. 1 illustrates a perspective view of one potential embodiment of a multipurpose animal sock 100 of the present invention in accordance with the disclosed architecture. The multipurpose animal sock 100 of the present invention is designed to be used as an indoor and outdoor sock for cats, dogs and other animals. The sock 100 is configured to be worn outside in extreme temperatures to ensure a pet can still get exercise during inclement weather. More specifically, the sock 100 provides a contoured and secure fit and enclosure for the pet's paw and lower leg and increases traction and stability on the ground. The sock 100 is waterproof to protect the pet's legs, feet and paws, and provide breathability for comfort. In one embodiment, the sock 100 may also function as a mobility aid for animals with joint or neurological issues, such as hip dysplasia, by enhancing traction and reducing strain on limbs during movement. The sock 100 may be worn indoors to assist with walking on slippery surfaces and outdoors to protect from hot pavement or rough terrain.

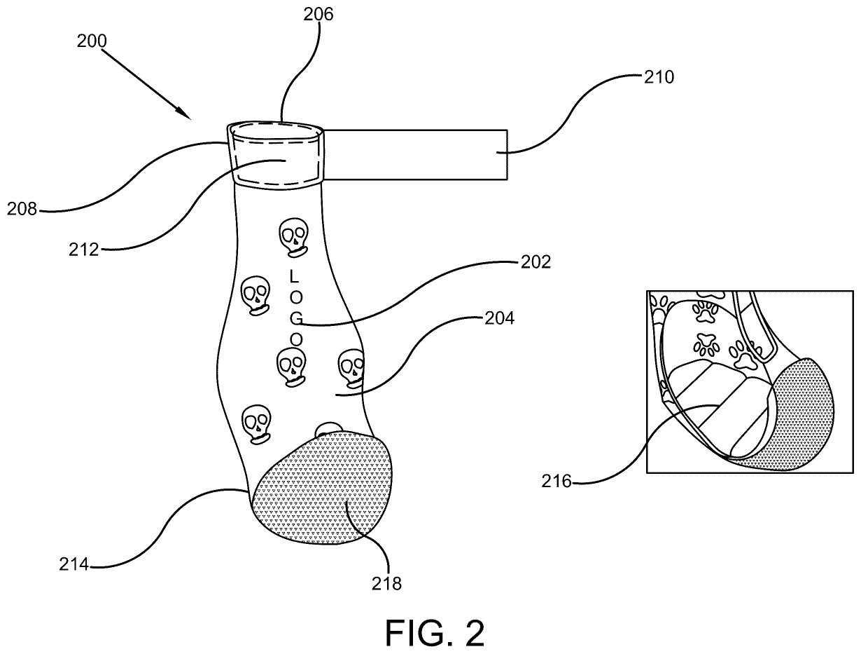

The sock 100 can be made from a plastic coated weatherproof fabric 102 and includes a lower leg portion 104 and a paw portion 106. The lower leg portion 104 of the sock 100 substantially surrounds the lower leg 4020 of the animal. The lower leg portion 104 is pulled and tugged to help adjust the position and orientation of the paw portion 106. The lower leg portion 104 can include a high-elastic cloth (i.e. cotton cloth). The sock 100 includes a top opening 108 for inserting the paw of an animal. The opening 108 can have an elastic band 110 or alternatively a hook and loop fastener (shown in FIG. 2) for securing around the lower leg of the animal. The elastic band 110 can have reflective strips to help the pet to be visible in low light or dark areas. The sock 100 includes a textured sole 112 along the bottom of the paw portion 106 made from silicon dots material such as resin rubber or polyurethane for providing tactile feeling to the paw of the animal. The sole 112 also provides improved traction with any surface and thus increases the safety of the animal. The rubber sole 112 can be sewn to the bottom of the paw portion 106 to cover the paw pads of the animal. The sole 112 extends to cover the front toe area by forming a toc cap 114 of the sock 100 for providing adequate support to the toe of the animal. In one embodiment, the sole 112 may comprise a rubberized or silicone-based grip surface 113 configured to enhance traction on smooth indoor surfaces such as hardwood, tile or laminate flooring. This may reduce the risk of slips, falls, and associated joint strain, particularly in senior or mobility-impaired animals. The grip surface 113 may be comprised of but is not limited to any combination of raised or recessed textures, ridges, dot matrices, etc.

The sock 100 includes a heat-resistant insole layer 116 positioned inside the sock 100. In use, the paws of an animal are placed on the heat-resistant insole layer 116 which provides insulation and a soft material adjacent to the paws. The insole layer 116 is permanently placed and can be sewn or attached using an adhesive. The insole layer 116 can be manufactured from microfiber nylon material which is both waterproof and insulating. The fibers on the insole 116 absorb heat, swelling and thickening to fill the gaps in the sock 100. In one embodiment, the insole layer 116 may be comprised of heat-resistant felt lining derived from materials such as but not limited to any combination of aramid fibers or flame-treated wool blends. This configuration may allow the sock 100 to withstand contact temperatures of ground surfaces, thereby protecting the animal's paw pads during contact with high-temperature surfaces.

The sock 100 is flexible and contours to the size and shape of the leg and paws of the animal. The sock 100 can be used with an animal including, without limitation, a dog, a cat and other animals having a soft foot-like lower leg region of a mammal, generally a quadruped, that has claws. The sock 100 is configured to substantially cover the paw of an animal to protect against heat, debris, snow, ice, road salt, moisture and irritants. In one embodiment, the sock 100 may include a digit-separating structure 700 wherein each toe of the paw is individually enclosed or partially enclosed using a thong-like stitch configuration. This configuration may be analogous to a yoga sock and is intended to support natural paw mechanics, promote proprioception, allow for exposed claws, and maintain health of joints, muscles, and nails. The digit separation may also support natural behaviors such as digging, scratching, and scent marking. In another embodiment, the socket 100 is comprised of a plurality of individual toe-receiving areas 702 instead of having digit-separating structures 700.

FIG. 2 illustrates a perspective view showing another embodiment of an insulating animal paw sock of the present invention in accordance with the disclosed architecture. In the present embodiment, the sock 200 includes a logo or any other indicia 202 on the exterior surface 204 of the sock 200. The indicia 202 can be used for marketing and branding purposes. The top opening 206 includes a hook fastener 208 and a loop fastener flap 210. The loop fastener flap 210 is configured to wrap around the hook fastener 208 to secure the sock 200 around the leg of an animal in a snug and comfortable fit. This ensures a secure wrapping of the sock 200 around the leg of the animal and prevents the sock 200 from slipping when the animal walks or runs. The loop fastener flap 210 can have a reflective coating 212 for light reflectivity, increased visibility, and safety during nighttime. Alternatively, the sock 200 may utilize a strap-free, form-fitting design that eliminates the need for bulky fasteners, reducing the likelihood of pressure sores and gait disruption. The sock 200 may be comprised of a stretch fabric blend such as but not limited to cotton, nylon, and spandex, configured for comfort, breathability, and elasticity.

The sock 200 includes a rubber sole 214 for gripping onto any surface, thereby increasing traction and providing stability and support. A toe cap 218 is used for securing the toe of the animal wearing the sock 200, and can be made from rubber having the same or different texture from the rubber sole 214. Further, the sock 200 includes an inner insulating insole 216 for providing insulation from hot or cold surfaces, and a barrier between the pet's paw and the surface therebelow, upon which the animal walks when the sock 100 is donned by the animal. The sock 100 can be made from flexible material that allows the sock 200 to securely fit to both narrow and wide paws.

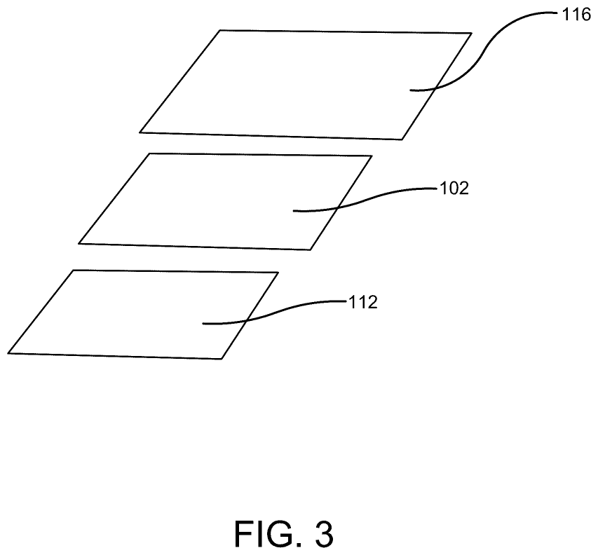

FIG. 3 illustrates a perspective view showing another layered structure of the paw portion of the multipurpose animal sock 100 of FIG. 1 in accordance with the disclosed architecture. Specifically, the paw portion of the sock 100 includes a three-layered structure with the insulating insole 116 as the top or inner layer. The insulating insole 116 is positioned inside the sock 100 and is configured to provide insulation to the paws of a pet from hot or cold surfaces on which the pet is walking or running. The insole 116 also provides a cushion effect to the paws and thus helps the pet in walking comfortably, even on a hard or uneven floor or terrain. The middle layer can include the fabric 102 of the sock 100. The fabric 102 is breathable, weatherproof and comfortable for the paws of the animal. The fabric 102 also includes some insulating properties that help in providing insulation to the paws of the animal wearing the sock 100. The insulating insole 116 can be sewn or permanently attached to the fabric 102 using an adhesive.

The bottom or outer layer is the textured rubber sole 112 that is used for increasing traction, support, protection, and stability with the surface on which the animal is walking. The sole 112 is also used for providing tactile feel to the paws of the animal. The three-layered structure 116,102,112 of the paw portion can be used in all the embodiments of the present invention and is used for providing effective support, traction and insulation to an animal wearing the sock.

It should be noted that animals do not resist wearing the socks on their feet and also do not attempt to remove them once worn. Further, the sock 100 is easy to wear and eliminates the need of wearing a separate boot.

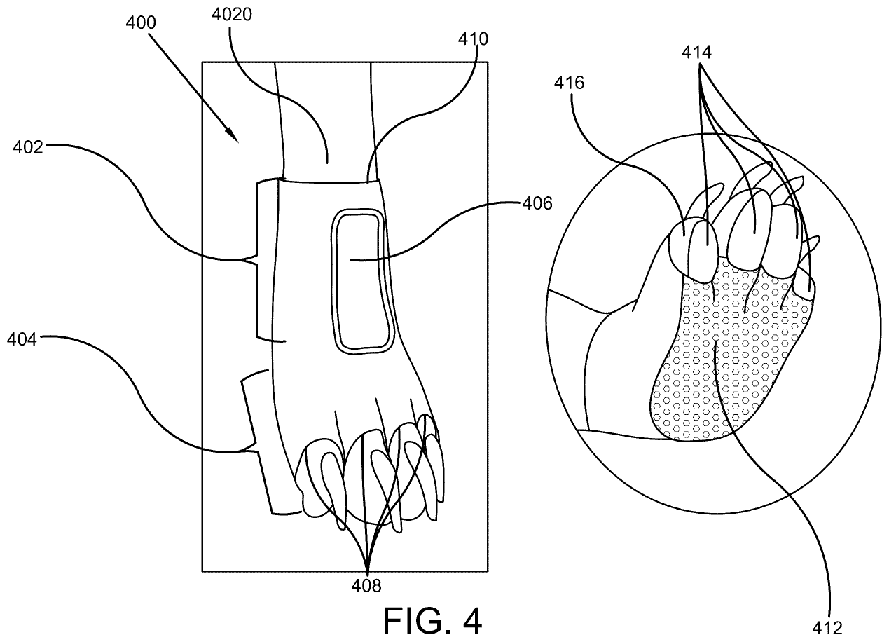

FIG. 4 illustrates a perspective view of a third embodiment of the multipurpose animal paw safety sock of the present invention in accordance with the disclosed architecture. In the present embodiment, the sock 400 has an appearance similar to half finger gloves. The sock 400 includes a lower leg portion 402 configured to receive the lower leg 4020 of an animal through the sock opening 410 for wearing the sock 400. The paw portion 404 is used for covering the paws and ankle of the animal. The paw portion 404 includes a plurality of claw and toe openings 408 that are used for the claws and toes of the animal to be exposed to the environment. This is useful for the pets who are uncomfortable in wearing the socks/boots that completely cover the paws of the animal. The claws and at least the tops of the toes of the animal wearing the sock 400 can be exposed by the sock 400.

For providing traction, support and stability to the paw 416, the paw portion 404 includes a rubber sole 412. Advantageously, individual paw supporting members 414 extend from the sole 412 to protect a portion of the underside part of the paws 416 (i.e. the underside of the toes of the animal). The paw supporting members 414 conform to the shape of the paws and/or toes and protect the claws/nails from physical injury in addition to protecting the paw pads (i.e. toes) from hot or cold surfaces.

The lower leg portion 402 includes a transparent portion 406 that can be used for viewing skin and a portion of the leg covered by the sock 400 without removing the sock 400. This is useful to view dust, debris or any other irritant present within the sock 400.

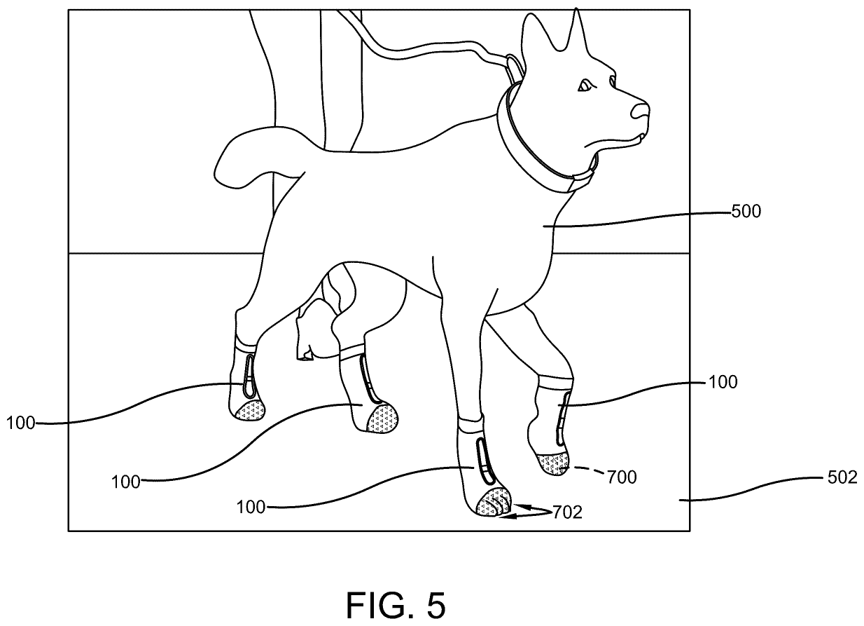

FIG. 5 illustrates a perspective view showing a dog running with the multipurpose sock of the present invention on a potentially hot surface in accordance with the disclosed architecture. As shown, the dog 500 is running/walking while wearing the socks 100 on each of the four legs on a potentially hot surface 502. The socks 100 are comfortably and securely fitted to the dog's legs, feet, and paws and protect the dog from the environment with synthetic rubber soles and insulating insoles.

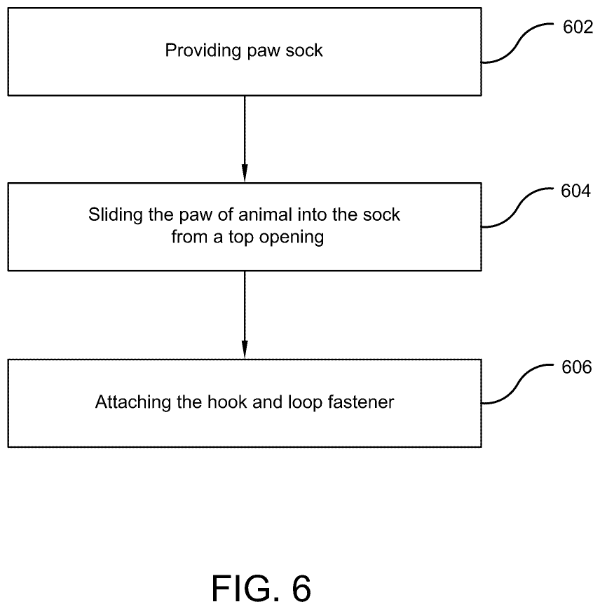

FIG. 6 illustrates a flowchart showing an exemplary method for donning the sock of the present invention on a paw of an animal in accordance with the disclosed architecture. Initially, a paw sock is provided with the paw sock having a lower leg portion and a paw portion (Step 602). Then, sliding the paw into the sock from a top opening with the lower leg portion supporting the lower leg and paw portion supporting the paw (Step 604). Thereafter, attaching the hook and loop fastener around the top opening to secure the sock (Step 606).

It should be appreciated that the socks of various embodiments of the present invention are available in different sizes such as small(S), medium (M), large (L) and extra-large (XL). The socks act as shoes or boots for the animals and protect a pet's feet and paws from hazardous environmental conditions, abrasion, dirt and chemicals, as well as cold and hot weather.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paw sock”, “sock”, “multipurpose sock”, and “multipurpose animal paw safety sock” are interchangeable and refer to the multipurpose animal paw safety sock 100,200,400 of the present invention.

Notwithstanding the forgoing, the multipurpose animal paw safety sock 100,200,400 of the present invention can be of any suitable size and configuration as is known in the art without affecting the overall concept of the invention, provided that it accomplishes the above-stated objectives. One of ordinary skill in the art will appreciate that the size, configuration and material of the multipurpose animal paw safety sock 100, 200, 400 as shown in the FIGS. are for illustrative purposes only, and that many other sizes and shapes of the multipurpose animal paw safety sock 100, 200, 400 are well within the scope of the present disclosure. Although the dimensions of the multipurpose animal paw safety sock 100, 200, 400 are important design parameters for user convenience, the multipurpose animal paw safety sock 100, 200, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal paw protector comprising:
a lower leg portion configured to surround a lower leg of an animal;
a paw portion extending from the lower leg portion and configured to enclose a paw of the animal;
a top opening positioned at an upper end of the lower leg portion for receiving the paw of the animal;
a sole attached to a bottom of the paw portion, the sole comprising a textured surface; and
an insole layer positioned inside the paw portion, the insole layer.

2. The animal paw protector of claim 1, wherein the top opening is comprised of a hook and loop fastener.

3. The animal paw protector of claim 1, wherein the textured surface is comprised of a raised texture or a recessed texture.

4. The animal paw protector of claim 1, wherein the temperature-resistant material is comprised of a heat-resistant felt lining.

5. The animal paw protector of claim 4, wherein the heat-resistant felt lining is comprised of an aramid fiber or a flame-treated wool blend.

6. The animal paw protector of claim 1, wherein the insole layer is comprised of a waterproof material.

7. The animal paw protector of claim 1, wherein the insole layer is comprised of an insulating material.

8. The animal paw protector of claim 1, wherein the lower leg portion is comprised of a transparent portion.

9. An animal paw protector comprising:
a lower leg portion configured to surround a lower leg of an animal;
a paw portion extending from the lower leg portion and configured to enclose a paw of the animal, wherein the paw portion is comprised of a digit-separating structure;
a top opening positioned at an upper end of the lower leg portion for receiving the paw of the animal;
a sole attached to a bottom of the paw portion, the sole comprising a textured surface; and
an insole layer positioned inside the paw portion, the insole layer comprising a temperature-resistant material.

10. The animal paw protector of claim 9, wherein the digit-separating structure is comprised of a thong-like stitch.

11. The animal paw protector of claim 9, wherein the top opening is comprised of a hook and loop fastener.

12. The animal paw protector of claim 9, wherein the textured surface is comprised of a raised texture or a recessed texture.

13. The animal paw protector of claim 9, wherein the top opening is comprised of an elastic band.

14. The animal paw protector of claim 13, wherein the elastic band is comprised of a reflective strip.

15. An animal paw protector comprising:
a lower leg portion configured to surround a lower leg of an animal;
a paw portion extending from the lower leg portion and configured to enclose a paw of the animal, wherein the paw portion is comprised of a plurality of individual toe receiving areas;
a top opening positioned at an upper end of the lower leg portion for receiving the paw of the animal;
a sole attached to a bottom of the paw portion, the sole comprising a textured surface; and
an insole layer positioned inside the paw portion, the insole layer comprising a temperature-resistant material.

16. The animal paw protector of claim 15, wherein the digit-separating structure is comprised of a thong-like stitch.

17. The animal paw protector of claim 15, wherein the top opening is comprised of a hook and loop fastener.

18. The animal paw protector of claim 15, wherein the textured surface is comprised of a raised texture or a recessed texture.

19. The animal paw protector of claim 15, wherein the temperature-resistant material is comprised of a heat-resistant felt lining.

20. The animal paw protector of claim 19, wherein the heat-resistant felt lining is comprised of aramid fibers or flame-treated wool blends.
